(19) United States
(12) Patent Application Publication
(10) Pub. No.: US 2023/0206906 A1
(43) Pub. Date: Jun. 29, 2023

(54) ELECTRONIC DEVICE, METHOD OF CONTROLLING THE SAME, AND RECORDING MEDIUM HAVING RECORDED THEREON PROGRAM

(71) Applicant: Samsung Electronics Co., Ltd., Suwong-si (KR)

(72) Inventors: Byunguk CHOI, Suwon-si (KR); Chiyoun PARK, Suwon-si (KR); Kangwook LEE, Suwon-si (KR)

(21) Appl. No.: 17/975,043

(22) Filed: Oct. 27, 2022

Related U.S. Application Data
(63) Continuation of application No. PCT/KR2022/015383, filed on Oct. 12, 2022.

(30) Foreign Application Priority Data
Dec. 28, 2021 (KR) 10-2021-0190338
Jan. 6, 2022 (KR) 10-2022-0002352

(51) Int. Cl. G10L 15/06; G10L 15/16; G10L 15/00

(52) U.S. Cl. CPC G10L 15/063; G10L 15/16; G10L 15/005; G10L 2015/223

(57) ABSTRACT

An electronic device and method for translating first text including a plurality of languages into second text including a single language from among the plurality of languages, is provided. The electronic device includes a user interface device configured to receive an input of a user regarding the first text and output the second text, a memory storing instructions, and a processor configured to execute the instructions to control the electronic device to identify the first text, apply the first text to an artificial intelligence (AI) model trained based on a corpus in which words of the plurality of languages are mapped to each other, identify the second text corresponding to the first text from the trained AI model, and display the second text.

### CROSS-REFERENCE TO RELATED APPLICATION(S)

This application is a continuation application, claiming priority under § 365(c), of an International application No. PCT/KR2022/015383, filed on Oct. 12, 2022, which is based on and claims the benefit of a Korean patent application number 10-2021-0190338, filed on Dec. 28, 2021, in the Korean Intellectual Property Office, and of a Korean patent application number 10-2022-0002352, filed on Jan. 6, 2022, in the Korean Intellectual Property Office, the disclosure of each of which is incorporated by reference herein in its entirety.

### TECHNICAL FIELD

The disclosure relates to an electronic device, a method of controlling the electronic device, and a recording medium having recorded thereon a program.

### BACKGROUND ART

An artificial intelligence (AI) system is a computer system that may exhibit human-level intelligence and get smarter through self-learning and making decisions, unlike an existing rule-based smart system. As AI systems are used, their recognition rate improves and users' tastes may be understood more accurately, and thus, existing rule-based smart systems are gradually being replaced by deep learning-based AI systems.

AI technology includes machine learning (e.g., deep learning) and element technologies using machine learning.

Machine learning is algorithm technology that self-classifies/learns characteristics of input data, and element technologies using a machine learning algorithm such as deep learning include technical fields such as visual understanding, reasoning/prediction, knowledge representation, motion control, and linguistic understanding.

Visual understanding is technology for recognizing and processing objects in the manner of a human visual system, and includes object recognition, object tracking, image retrieval, human recognition, scene understanding, three-dimensional (3D) reconstruction/localization, and image enhancement.

Reasoning/prediction is technology for determining and then logically reasoning and predicting information, and includes knowledge/probability-based reasoning, optimization prediction, preference-based planning, and recommendation.

Knowledge representation is technology for automating human experience information into knowledge data, and includes knowledge construction (data generation/classification), and knowledge management (data utilization). Motion control is technology for controlling autonomous driving of a vehicle and motion of robots, and includes motion control (navigation, collision, and driving), and manipulation control (behavior control).

Linguistic understanding is technology for recognizing and applying/processing human languages/characters, and includes natural language processing, machine translation, dialog systems, question answering, and speech recognition/synthesis.

The above information is presented as background information only to assist with an understanding of the disclosure. No determination has been made, and no assertion is made, as to whether any of the above might be applicable as prior art with regard to the disclosure.

### DESCRIPTION OF EMBODIMENTS

### Technical Problem

Aspects of the disclosure are to address at least the above-mentioned problems and/or disadvantages and to provide at least the advantages described below. Accordingly, an aspect of the disclosure is to provide an electronic device and a method of translating a mixed language text including a plurality of languages into a single language text including one language from among the plurality of languages by using the electronic device.

Additional aspects will be set forth in part in the description which follows and, in part, will be apparent from the description, or may be learned by practice of the presented embodiments.

### Solution to Problem

In accordance with an aspect of the disclosure, an electronic device for translating a first text including a plurality of languages into a second text including a single language from among the plurality of languages is provided. The electronic device includes a user interface device configured to receive an input of a user regarding the first text and output the second text. The electronic device includes a memory storing instructions. The electronic device includes a processor. The processor is configured to execute the instructions to control the electronic device to identify the first text, apply the first text to an artificial intelligence (AI) model trained based on a corpus in which words of a plurality of languages are mapped to each other, identify the second text output corresponding to the first text from the trained AI model, and display the second text.

In accordance with another aspect of the disclosure, a method by which an electronic device translates a first text including a plurality of languages into a second text including a single language from among the plurality of languages is provided. The method includes receiving, by a processor of the electronic device, an input of a user regarding the first text, identifying, by the processor, the first text, applying the first text to an artificial intelligence (AI) model trained based on a corpus in which words of a plurality of languages are mapped to each other, identifying, by the processor, the second text output corresponding to the first text from the trained AI model, and displaying, by the processor, on the electronic device, the second text.

According to an embodiment of the disclosure, a computer-readable recording medium may have recorded thereon a program for performing an embodiment of the method, on a computer.

According to an embodiment of the disclosure, a computer-readable recording medium may store therein an application for executing a function of at least one of embodiments of the method.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram for describing an electronic device for translating a mixed language text into a single language text, according to an embodiment of the disclosure;

FIG. 2 is a flowchart illustrating a method by which an electronic device translates a mixed language text into a single language text, according to an embodiment of the disclosure;

FIG. 3 is a diagram for describing a corpus used to train an artificial intelligence (AI) model, according to an embodiment of the disclosure;

FIG. 4 is a diagram for describing a training text used to train an AI model, according to an embodiment of the disclosure;

FIG. 5 is a diagram for describing a text used to train an AI model, according to an embodiment of the disclosure;

FIG. 6 is a diagram for describing a method of training an AI model by using a mixed language text, according to an embodiment of the disclosure;

FIG. 7 is a diagram for describing a method of training an AI model by using a mixed language text, according to an embodiment of the disclosure;

FIG. 8 is a block diagram illustrating an electronic device, according to an embodiment of the disclosure;

FIG. 9 is a block diagram illustrating a software module of a memory included in an electronic device, according to an embodiment of the disclosure;

FIG. 10 is a block diagram illustrating a server, according to an embodiment of the disclosure; and

FIG. 11 is a block diagram illustrating a software module of a memory included in a server, according to an embodiment of the disclosure.

Throughout the drawings, like reference numerals will be understood to refer to like parts, components, and structures.

### MODE OF DISCLOSURE

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the disclosure, the expression “at least one of a, b or c” indicates only a, only b, only c, both a and b, both a and c, both b and c, all of a, b, and c, or variations thereof.

Principles and embodiments of the disclosure will be described in detail in order to fully convey the scope of the disclosure and enable one of ordinary skill in the art to embody and practice the disclosure. The embodiments of the disclosure may be implemented in various forms. The embodiments of the disclosure may be used individually, or two or more of the embodiments of the disclosure may be combined.

The same reference numerals denote the same elements throughout the specification. All elements of the embodiments of the disclosure are not described in the specification, and descriptions of matters well known in the art to which the disclosure pertains or repeated descriptions between the embodiments of the disclosure will not be given. Also, the term “part” or “portion” used herein may be a hardware component such as a processor or a circuit and/or a software component executed by a hardware component such as a processor. According to embodiments of the disclosure, a plurality of parts or portions may be embodied by a single unit or element, or a single part or portion may include a plurality of elements. Hereinafter, operation principles and embodiments of the disclosure will be described in detail with the accompanying drawings.

Some embodiments of the disclosure may be represented by functional block configurations and various processing operations. Some or all of functional blocks may be implemented by various numbers of hardware and/or software configurations for performing certain functions. For example, the functional blocks of the disclosure may be implemented by one or more microprocessors or by circuit configurations for a certain function. Also, for example, the functional blocks of the disclosure may be implemented in various programming or scripting languages. The functional blocks may be implemented in an algorithm executed by one or more processors. Also, in the disclosure, the prior art may be employed for electronic configuration, signal processing, and/or data processing. The terms such as “mechanism,” “element,” “means,” and “configuration” may be used broadly and are not limited to mechanical and physical configurations.

Throughout the specification, when a part is “connected” to another part, the part may be “directly connected” to the other part, or may be “electrically connected” to the other part with another element therebetween. In addition, when a part “includes” a certain element, the part may further include another element instead of excluding the other element, unless stated otherwise.

Also, lines or members connecting elements illustrated in the drawings are merely illustrative of functional connections and/or physical or circuit connections. In an actual device, connections between components may be represented by various functional connections, physical connections, or circuit connections that are replaceable or added.

It will be understood that, although the terms “first,” “second,” etc. may be used herein to describe various elements, these elements should not be limited by these terms. The above terms may be used only to distinguish one component from another.

An electronic device and/or a server according to the disclosure may use an artificial intelligence (AI) model in order to reason or predict the reliability of a federated learning result.

Reasoning/prediction is technology for determining and then logically reasoning and predicting information, and includes knowledge/probability-based reasoning, optimization prediction, preference-based planning, and recommendation.

AI-related functions according to the disclosure are performed by a processor and a memory. The processor may include one or more processors. In this case, the one or more processors may include a general-purpose processor such as a central processing unit (CPU), an application processor (AP), or a digital signal processor (DSP), a graphics processor such as a graphics processing unit (GPU) or a vision processing unit (VPU), or an AI processor such as a neural processing unit (NPU). The one or more processors control input data to be processed according to a pre-defined operation rule or an Al model stored in the memory. Alternatively, when the one or more processors are AI processors, the AI processors may be designed in a hardware structure specialized for processing a specific Al model. The processor may perform a preprocessing operation of converting data applied to an AI model into a form suitable for application to the AI model.

The AI model may be created through learning. Here, “created through learning” denotes that, as a basic Al model is trained by using a plurality of pieces of training data according to a learning algorithm, a pre-defined operation rule or an Al model set to perform desired characteristics (or purposes) is created. Such learning may be performed on a device in which Al according to the disclosure is conducted or may be performed through a separate server and/or system. Examples of the learning algorithm include, but are not limited to, supervised learning, unsupervised learning, semi-supervised learning, and reinforcement learning.

The AI model may include a plurality of neural network layers. Each of the plurality of neural network layers has a plurality of weight values, and a neural network operation is performed through an operation between an operation result of a previous layer and the plurality of weight values. The weight values of the plurality of the neural network layers may be optimized through a result of training the Al model. For example, the plurality of weight values may be updated to reduce or minimize a loss value or a cost value obtained by the Al model during a learning process. An artificial neural network may include a deep neural network (DNN), for example, a convolutional neural network (CNN), a recurrent neural network (RNN), a restricted Boltzmann machine (RBM), a deep belief network (DBN), a bidirectional recurrent deep neural network (BRDNN), or a deep Q-network, but is not limited thereto.

The AI model of the disclose may be created by learning a plurality of text data input as training data based on a certain criterion. The AI model of the AI model may generate result data by performing a learned function corresponding to the input data, and may output the result data.

The AI model of the disclose may include a plurality of AI models trained to perform at least one function.

An AI model used in an embodiment of the disclosure may be implemented in various embodiments of the disclosure according to a manufacturer of an electronic device or a user of the electronic device, and is not limited to the above examples.

In an embodiment of the disclosure, an AI model may be built in at least one of an electronic device or a server. Although an AI model built in an electronic device is described as an example, the disclosure is not limited thereto. The AI model built in an electronic device described below may be applied by analogy to an AI model built in a server.

Hereinafter, embodiments of the disclosure will be described in detail with reference to the drawings.

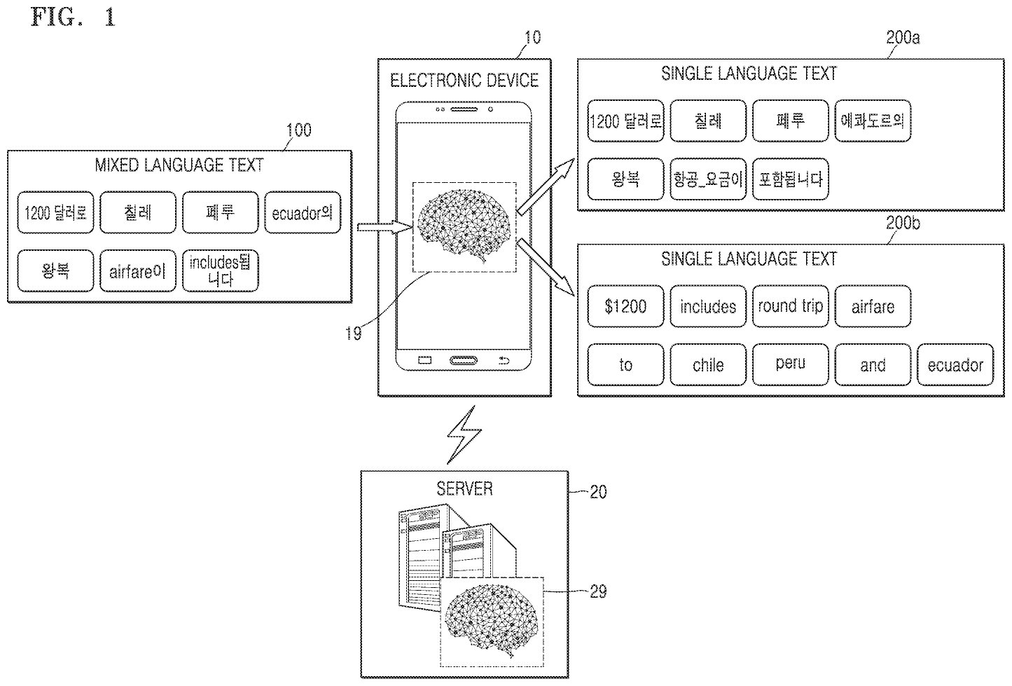

FIG. 1 is a diagram for describing an electronic device 10 for translating a mixed language text into a single language text, according to an embodiment of the disclosure.

According to an embodiment of the disclosure, an electronic device 10 may include a computing device such as a general-purpose computer (e.g., a personal computer (PC)) or a mobile device (e.g., a smailphone or a tablet PC, etc.) including an AI model 19. Also, the electronic device 10 may include a computing device such as a general-purpose computer (e.g., a PC) or a mobile device (e.g., a smailphone or a tablet PC, etc.) which may transmit and receive data through a network to and from a server 20 including an AI model 29. Also, the electronic device 10 may include the server 20 including the AI model 29. At least some of the following embodiments of the disclosure may be implemented as a result of an operation of one electronic device, or may be implemented as a result of operations of at least two electronic devices.

According to an embodiment of the disclosure, the server 20 may transmit and receive data to and from the electronic device 10. For example, the server 20 may apply data received from the electronic device 10 to the AI model 29, and may transmit data output from the AI model 29 to the electronic device 10. For example, the server 20 may transmit data on the AI model 19 to be built in the electronic device 10 to the electronic device 10. For example, the server 20 may transmit data used to update the AI model 19 built in the electronic device 10 to the electronic device 10.

Referring to FIG. 1, the electronic device 10 may receive an input of a user regarding a mixed language text 100 through a user interface device (e.g., a touchscreen including a user input unit and an output unit).

Referring to FIG. 1, the electronic device 10 may apply the mixed language text 100 to the AI models 19 and 29. For example, the electronic device 10 may apply the mixed language text 100 to the AI model 19 installed in the electronic device 10. The electronic device 10 may transmit the mixed language text 100 to the server 20 in order to apply the mixed language text 100 to the AI model 29 mounted on the server 20.

Referring to FIG. 1, the electronic device 10 may display, on the user interface device, single language texts 200a and 200b output from the AI model 19 or the AI model 29 corresponding to the mixed language text 100. For example, the electronic device 10 may display, on a display of the electronic device 10, the single language texts 200a and 200b output from the AI model 19 mounted on the electronic device 10. For example, the electronic device 10 may receive the single language texts 200a and 200b output from the AI model 29 mounted on the server 20 from the server 20, and may display the single language texts 200a and 200b on the display of the electronic device 10.

In an embodiment of the disclosure, the mixed language text 100 refers to a text including a plurality of languages. For example, the mixed language text 100 may include a sentence including Korean and English. For example, a sentence ‘1200 [symbol] [symbol] ecuador [symbol] airfare [symbol] include [symbol] may correspond to the mixed language text 100.

In an embodiment of the disclosure, each of the single language texts 200a and 200b refers to a text including one language. For example, each of the single language texts 200a and 200b may include a sentence including only English or Korean. For example, a sentence ‘1200 [symbol] [symbol] [symbol] [symbol] may correspond to the single language text 200a. A sentence ‘$1200 includes the round-trip airfare to Chile, Peru, and Ecuador.’ may correspond to the single language text 200b.

In an embodiment of the disclosure, a corpus refers to a sample of languages obtained for translation. For example, a corpus may include words of a plurality of languages which are mapped to each other.

In an embodiment of the disclosure, each of the AI models 19 and 29 may include a plurality of AI models trained to perform at least one function.

For example, the AI models 19 and 29 may include a model trained to generate and update a corpus, by identifying words from texts and mapping the identified words. The AI models 19 and 29 may include a model trained to generate and update a corpus based on words of a plurality of languages which co-occur from training texts including a plurality of languages. The co-occurrence of words denotes that words appear together in a text. A training text refers to text data that is training data used to train the AI models 19 and 29. The AI models 19 and 29 may include a model trained to generate and update a corpus generated by mapping words included in training texts in the order of frequency of co-occurrence.

In an embodiment of the disclosure, the AI models 19 and 29 may include a model trained to generate and update a corpus by merging collocations in a text. The AI models 19 and 29 may include a model trained to generate and update a corpus, by merging collocations based on the number of co-occurrences of words included in a text.

For example, the AI models 19 and 29 may include a model trained to generate training texts by using a corpus. The AI models 19 and 29 may include a model trained to generate a second training text, generated by replacing a first word of a first language (e.g., Korean) included in a first training text into a second word of a second language (e.g., English), based on a corpus. The AI models 19 and 29 may include a model trained to generate second training data, by replacing a first word with a second word mapped to have a meaning similar to a meaning of the first word, based on a corpus. The AI models 19 and 29 may include a model trained to generate second training data, by replacing a first word with a second word not mapped to the first word, based on a corpus.

For example, the AI models 19 and 29 may include at least one model trained to translate the mixed language text 100 including a plurality of languages (e.g., Korean and English) into the single language texts 200a and 200b each including only a single language (e.g., Korean or English). The AI models 19 and 29 may be trained with training texts to translate the mixed language text 100 into the single language texts 200a and 200b. The AI models 19 and 29 may be trained with a single language text including a single language and a mixed language text including a plurality of languages together as training texts. The AI models 19 and 29 may be trained with a training text in which collocations are merged. The AI models 19 and 29 may be trained with a training text so that a loss between a label and a text output from the AI models 19 and 29 in response to the input training text decreases. The AI models 19 and 29 may be trained with a training text so that a loss between a label and a text output from the AI models 19 and 29 in response to the input training text increases.

According to an embodiment of the disclosure, The electronic device 10 may accurately display a result of translating a mixed language text including a plurality of languages into a single language text including a single language without omission of key words.

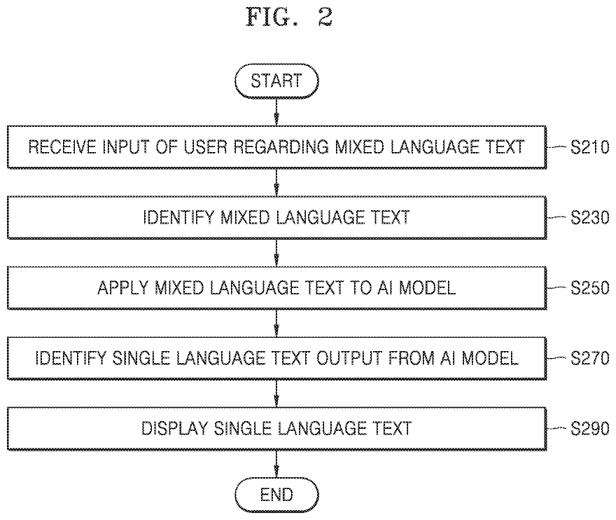

FIG. 2 is a flowchart illustrating a method by which an electronic device 10 translates a mixed language text into a single language text, according to an embodiment of the disclosure.

Referring to FIG. 2, in operation S210, the electronic device 10 may receive an input of a user regarding a mixed language text.

According to an embodiment of the disclosure, the electronic device 10 may receive an input of a user who inputs the mixed language text 100 through a user interface device. For example, the electronic device 10 may receive an input of a user who inputs a mixed language text to a text box through a keyboard.

According to an embodiment of the disclosure, the electronic device 10 may receive an input of a user who selects the mixed language text 100 through the user interface device. For example, the electronic device 10 may receive an input of a user who selects a mixed language text through a mouse.

According to an embodiment of the disclosure, the electronic device 10 may receive an input of a user who selects a language into which the mixed language text 100 is to be translated through the user interface device. For example, the electronic device 10 may receive an input of a user who selects a type of a language into which a mixed language text is to be translated through a touchscreen.

In operation S230, the electronic device 10 may identify the mixed language text.

According to an embodiment of the disclosure, the electronic device 10 may identify the mixed language text to be translated based on the input of the user. The electronic device 10 may identify characters constituting the mixed language text. The electronic device 10 may identify the mixed language text including a plurality of languages based on the characters included in the mixed language text.

According to an embodiment of the disclosure, the electronic device 10 may identify a base language from among the plurality of languages constituting the mixed language text. For example, the electronic device 10 may identify Korean as a base language from the mixed language text including Korean and English. The electronic device 10 may identify the base language based on the input of the user who selects a language into which the mixed language text is to be translated.

According to an embodiment of the disclosure, the electronic device 10 may identify collocations from among the plurality of words constituting the mixed language text. For example, the electronic device 10 may identify collocations based on a corpus. For example, the electronic device 10 may identify collocations by using an AI model that generates and updates a corpus by identifying the collocations.

According to an embodiment of the disclosure, the electronic device 10 may merge the identified collocations. The electronic device 10 may merge the collocations identified from the mixed language text into one word.

In operation S250, the electronic device 10 may apply the mixed language text to an AI model 19.

According to an embodiment of the disclosure, the electronic device 10 may apply the mixed language text identified in operation S230 to the AI model. For example, the electronic device 10 may apply the mixed language text to an AI model 19 built in the electronic device 10. For example, the electronic device 10 may transmit the mixed language text to a server 20, in order to apply the mixed language text to an AI model 29 built in the server 20.

According to an embodiment of the disclosure, the electronic device 10 may apply the mixed language text in which the collocations are merged to the AI model 19. For example, the electronic device 10 may display the merged collocations in accordance with a pre-determined rule, and may apply the mixed language text including the merged collocations to the AI model 19.

According to an embodiment of the disclosure, the electronic device 10 may apply information about the identified base language along with the mixed language text to the AI model 19. For example, the electronic device 10 may apply the information about the base language that is generated in accordance with a pre-determined rule along with the mixed language text to the AI model 19.

In operation S270, the electronic device 10 may identify a single language text output from the AI model 19. The electronic device 10 may identify a single language text from among data output from the AI model 19. For example, the electronic device 10 may identify a single language text from among data output from the AI model 19 built in the electronic device 10. For example, the electronic device 10 may receive a single language text output from the AI model 29 built in the server 20 from the server 20. The AI model 19, 29 may be an AI model trained to translate the mixed language text applied in operation S250 into a single language text.

According to an embodiment of the disclosure, the electronic device 10 may identify the single language text output from the AI model trained by using a corpus.

According to an embodiment of the disclosure, the AI model may be trained by using a corpus generated based on words of a plurality of languages co-occurring from training texts including a plurality of languages. The AI model may be trained by using a corpus generated by mapping words in the order of frequency of co-occurrence.

According to an embodiment of the disclosure, the AI model may be trained by using a corpus generated based on texts in which collocations are merged. The AI model may be trained by using a corpus generated by merging collocations based on the number of co-occurrences of words. The corpus used to train the AI model that outputs the single language text may be generated by an AI model trained to generate a corpus.

According to an embodiment of the disclosure, the electronic device 10 may identify the single language text output from the AI model trained by using a training text. The AI model may be trained with a first training text including a single language and a second training text including a plurality of languages.

According to an embodiment of the disclosure, the AI model may be trained by using a training text generated based on a corpus to which words of a plurality of languages which co-occur are mapped. The AI model may be trained by using a training text generated based on a corpus generated by mapping words in the order of frequency of co-occurrence. The AI model may be trained by using a training text in which collocations are merged. The AI model may be trained by using a training text in which collocations are merged based on the number of co-occurrences of words.

According to an embodiment of the disclosure, the AI model may be trained with a second training text generated by replacing a first word of a first language included in a first training text with a second word of a second language based on a corpus.

According to an embodiment of the disclosure, the AI model may be trained with a second training text so that a loss between a first training text and a third training text output from an AI model in response to the application of the second training text to the AI model decreases. In this case, the AI model may be trained with second training data generated by replacing a first word with a second word mapped to have a meaning similar to a meaning of the first word.

According to an embodiment of the disclosure, the AI model may be trained with a second training text so that a loss between a first training text and a third training text output from an AI model in response to the application of the second training text to the AI model increases. In this case, the AI model may be trained with second training data generated by replacing a first word with a second word not mapped to have a meaning similar to a meaning of the first word.

According to an embodiment of the disclosure, the training text used to train the AI model that outputs the single language text may be generated by an AI model trained to generate a training text by using a corpus.

In operation S290, the electronic device 10 may display the single language text.

According to an embodiment of the disclosure, the electronic device 10 may display the single language text identified in operation S270 by using the user interface device of the electronic device 10. For example, the electronic device 10 may display the single language text on a display unit of the electronic device 10. The AI model described in FIG. 2 may be the AI model 19 built in the electronic device 10 or the AI model 29 bulit in the server 20, but is not limited thereto.

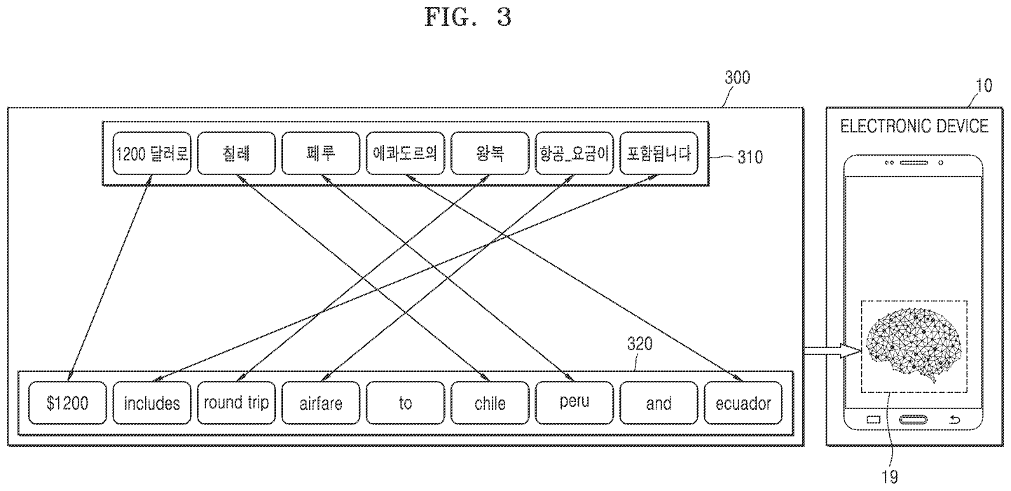

FIG. 3 is a diagram for describing a corpus used to train an AI model, according to an embodiment of the disclosure. One or more embodiments related to the AI model 19 built in the electronic device 10 described below may be applied by analogy to the AI model 29 built in the server 20.

Referring to FIG. 3, the electronic device 10 may train the AI model 19 by using a corpus 300 generated by mapping words of a plurality of languages. The corpus 300 used by the electronic device 10 to train the AI model 19 may be stored in the electronic device 10. The corpus 300 used by the electronic device 10 to train the AI model 19 may be received from the server 20.

According to an embodiment of the disclosure, the corpus 300 may be generated based on words identified from training texts 310 and 320. For example, the corpus 300 may be generated by mapping words included in the training texts 310 and 320. The corpus 300 may be generated by mapping words having similar meanings included in the training texts 310 and 320 to each other. The corpus 300 used to train the AI model 19 may be generated by an AI model trained to generate a corpus.

According to an embodiment of the disclosure, the corpus 300 may be generated based on words co-occurring from the training texts 310 and 320. Each of the training texts 310 and 320 may be a text including a single language or a mixed language text including a plurality of languages.

The training text 310 and the training text 320 may be texts having the same meaning and including different languages. For example, when it is assumed that the training text 310 is a first training text and the training text 320 is a second training text, the second training text 320 may be a text having the same meaning as the first training text 310 and obtained by translating the first training text 310 including Korean into English. The corpus 300 may be generated based on a result of co-occurrence of a first word included in the first training text 310 and a second word included in the second training text 320.

According to an embodiment of the disclosure, the AI model trained to generate a corpus may identify words from each of the first training text 310 and the second training text 320. The AI model trained to generate a corpus may identify the first word and the second word which co-occur, by arranging words included in the first training text 310 and the second training text 320 in a matrix. The AI model trained to generate a corpus may identify a frequency at which the first word and the second word co-occur. The AI model trained to generate a corpus may generate and update the corpus 300, by mapping the first word and the second word which co-occur to cross-reference.

The corpus 300 may be stored as data in a memory of the electronic device 10 or a memory and/or a database (DB) of the server 20.

According to an embodiment of the disclosure, the corpus 300 may be generated by mapping words included in the training texts 310 and 320 to each other in the order of frequency of co-occurrence. The AI model trained to generate a corpus may identify words having a high frequency of co-occurrence from among words included in the first training text 310 and the second training text 320, by arranging the words respectively included in the first training text 310 and the second training text 320 in a matrix. The AI model trained to generate a corpus may arrange words included in the first training text 310 and the second training text 320 in the order of frequency of co-occurrence. The AI model trained to generate a corpus may generate and update the corpus 300, by mapping words to each other to cross-reference in the order of arrangement.

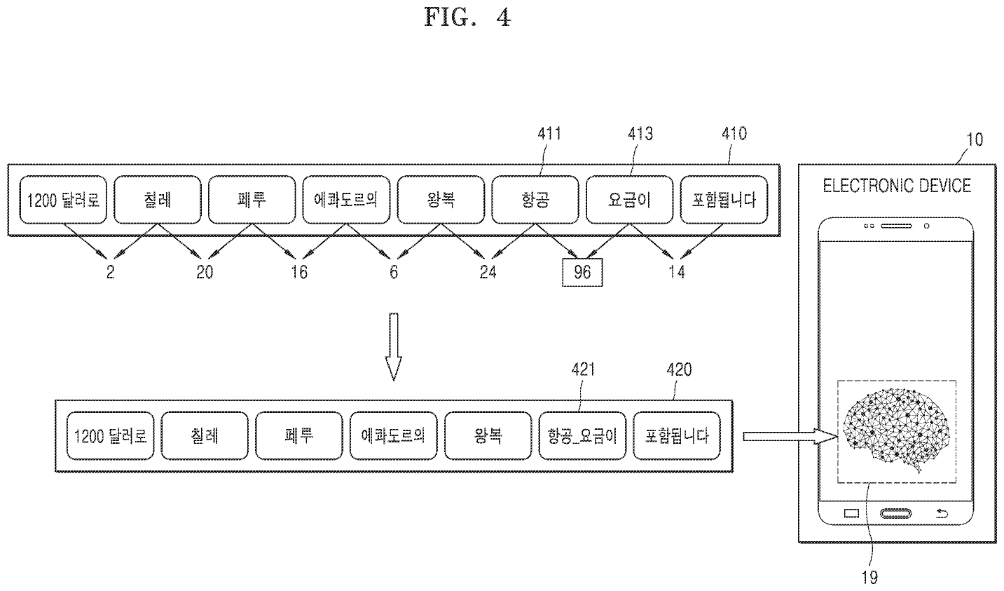

According to an embodiment of the disclosure, the corpus 300 may be generated based on a training text in which collocations are merged. The AI model trained to generate a corpus may generate the corpus 300 from a training text in which collocations are merged. Words having a highest number of consecutive arrangements from among words in a training text may be merged as collocations. A method of merging collocations is described below with reference to FIG. 4. The AI model trained to generate a corpus may identify the merged collocations as a word. The AI model trained to generate a corpus may generate a corpus based on the number and/or frequency of co-occurrence of merged collocations and words.

Because the AI model 19 is trained with the corpus 300, the AI model 19 may output a result of accurately translating a mixed language text including a plurality of languages into a single language text including a single language without omission of key words.

FIG. 4 is a diagram for describing a training text used to train an AI model, according to an embodiment of the disclosure. One or more embodiments regarding the AI model 19 built in the electronic device 10 described below may be applied by analogy to the AI model 29 built in the server 20.

Referring to FIG. 4, the electronic device 10 may train the AI model 19 by using a training text 420 in which collocations in which two or more words are combined to represent one meaning are merged. Training texts 410 and 420 used by the electronic device 10 to train the AI model 19 may be stored in the electronic device 10. The training texts 410 and 420 may be received from the server 20. Each of the training texts 410 and 420 may be a single language text including a single language or a mixed language text including a plurality of languages.

According to an embodiment of the disclosure, the training text 420 may be generated by merging collocations 421 from among words included in the training text 410. For example, the training text 420 may be generated by merging words having a highest number of consecutive arrangements from among the words included in the training text 410 as collocations. The training text 420 may be generated by an AI model trained to merge collocations.

The AI model trained to merge collocations may identify the words included in the training text 410. The AI model trained to merge collocations may identify the number of times the identified words are located adjacent to each other. The AI model trained to merge collocations may generate the training text 420, by merging words having a highest number of consecutive arrangements as collocations.

For example, referring to FIG. 4, the training text 410 may include a sentence ‘1200 [symbol] [symbol] [symbol] [symbol] The AI model trained to merge collocations may identify words ‘1200 [symbol] [symbol] [symbol] and [symbol] from the training text 410. The AI model trained to merge collocations may identify that ‘1200 [symbol] and [symbol] are consecutively arranged 2 times, [symbol] and [symbol] are consecutively arranged 20 times, [symbol] and [symbol] are consecutively arranged 16 times, [symbol] and [symbol] are consecutively arranged 6 times, [symbol] and [symbol] are consecutively arranged 24 times, [symbol] and [symbol] are consecutively arranged 96 times, and [symbol] and [symbol] are consecutively arranged 14 times. The AI model trained to merge collocations may identify from the training text 410 that word [symbol] 411 and word [symbol] 413 are consecutively arranged at a highest frequency. The AI model trained to merge collocations may generate the training text 420 by merging the word [symbol] 411 and the word [symbol] 413 as collocations 421.

The training text 420 may be stored as data in a memory of the electronic device 10 or a memory and/or a database of the server 20.

Because the AI model 19 is trained with the training text 420, the AI model 19 may output a result of accurately translating a mixed language text including a plurality of languages into a single language text including a single language without omission of key words.

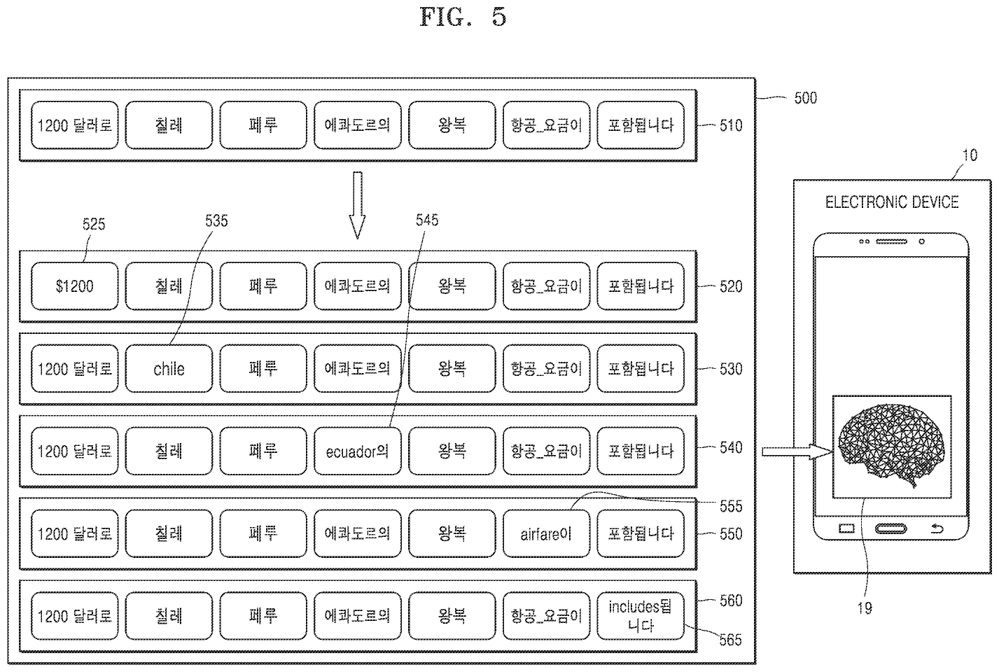

FIG. 5 is a diagram for describing a text used to train an AI model, according to an embodiment of the disclosure. One or more embodiments regarding the AI model 19 built in the electronic device 10 described below may be applied by analogy to an AI model 29 built in the server 20.

Referring to FIG. 5, the electronic device 10 may train the AI model 19 to output a single language text corresponding to a mixed language text by using a training text set 500. The training text set 500 may be stored in the electronic device 10. The training text set 500 may be received from the server 20. Training texts 520, 530, 540, 550, and 560 included in the training text set 500 may be generated by using the corpus 300 described with reference to FIG. 3. The training texts 520, 530, 540, 550, and 560 included in the training text set 500 may be generated by an AI model trained to generate a training text.

According to an embodiment of the disclosure, the training texts 520, 530, 540, 550, and 560 included in the training text set 500 may be generated by replacing at least one word included in a training text 510. For example, the training texts 520, 530, 540, 550, and 560 may be generated by replacing a word of the training text 510 including Korean with a mapped English word.

Referring to FIG. 5, for example, the training text 510 may include a sentence ‘1200 [symbol] [symbol] [symbol] [symbol] The AI model trained to generate a training text may identify words ‘1200 [symbol] [symbol] [symbol] and [symbol] from the training text 510.

The AI model trained to generate a training text may generate the training texts 520, 530, 540, 550, and 560 by replacing one or more words included in the training text 510. The AI model trained to generate a training text may replace a word based on the corpus 300 described with reference to FIG. 3. In detail, the AI model trained to generate a training text may generate the training texts 520, 530, 540, 550, and 560, by replacing the word ‘1200 [symbol] included in the training text 510 with a word ‘$1200’ 525, the word [symbol] with a word ‘chile’ 535, the word [symbol] with a word ‘ecuador’ 545, collocations [symbol] with a word ‘airfare’ 555, and the word [symbol] with a word ‘includes’ 565. The AI model trained to generate a training text may generate the training text set 500 including the training text 510 and the training texts 520, 530, 540, 550, and 560 generated by replacing one or more words included in the training text 510.

The training text set 500 may be stored as data in a memory of the electronic device 10 or a memory and/or a database of the server 20.

According to an embodiment of the disclosure, the AI model 19 may be trained with the training text 510 included in the training text set 500 and the training texts 520, 530, 540, 550, and 560 generated by replacing one or more words included in the training text 510. The training text 510 may be a text including one or more languages. The training texts 520, 530, 540, 550, and 560 may be texts including a plurality of languages.

Because the AI model 19 is trained with the training text set 500, the AI model 19 may output a result of accurately translating a mixed language text including a plurality of languages into a single language text including a single language without omission of key words.

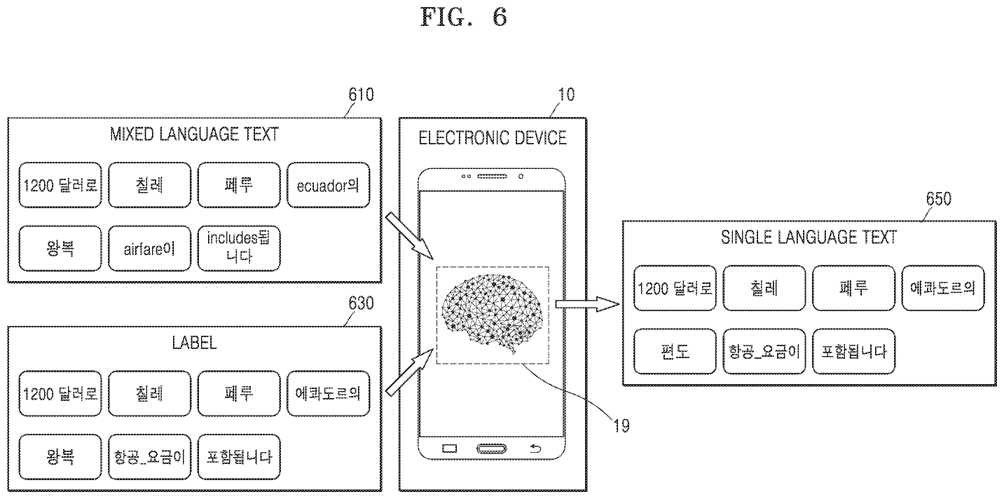

FIG. 6 is a diagram for describing a method of training an AI model by using a mixed language text, according to an embodiment of the disclosure. One or more embodiments regarding the AI model 19 built in the electronic device 10 described below may be applied by analogy to the AI model 29 built in the server 20.

Referring to FIG. 6, the electronic device 10 may train the AI model 19 to output a single language text 650 corresponding to a mixed language text 610 by using the mixed language text 610 including a plurality of languages and a label 630 including a single language. For example, the electronic device 10 may train the AI model 19 to output a single language text including Korean or a single language text including English corresponding to a mixed language text in which Korean is a base language and English is mixed.

The label 630 may be the training text 510 (see FIG. 5) in which a word is not replaced as described with reference to FIG. 5. For example, the label 630 may include a sentence ‘1200

[symbol]

[symbol]

[symbol]

[symbol]

The mixed language text 610 may be the training texts 520, 530, 540, 550, and 560 (see FIG. 5) generated as described with reference to FIG. 5. For example, the mixed language text 610 may include a sentence ‘1200 [symbol] ecuador [symbol] [symbol] airfare [symbol] includes

[symbol]

According to an embodiment of the disclosure, the mixed language text 610 may be generated by replacing at least one word included in the training text 510 (see FIG. 5) with a word of another language having a similar meaning For example, the mixed language text 610 may be the training texts 520, 530, 540, 550, and 560 (see FIG. 5) generated when an AI model trained to generate a training text replaces one or more words included in the training text 510 (see FIG. 5) based on the corpus 300 described with reference to FIG. 3.

According to an embodiment of the disclosure, the AI model 19 may be trained with the mixed language text 610 so that a loss between the label 630 and the single language text 650 that is output in response to the application of the mixed language text 610 decreases. For example, the AI model 19 may be trained with the label 630 and the mixed language text 610 to output a sentence ‘1200 [symbol] [symbol] [symbol] [symbol] which is similar to the label 630, as the single language text 650.

Because the AI model 19 is trained with the mixed language text 610 by using the label 630, the AI model 19 may output a result of accurately translating a mixed language text including a plurality of languages into a single language text including a single language without omission of key words.

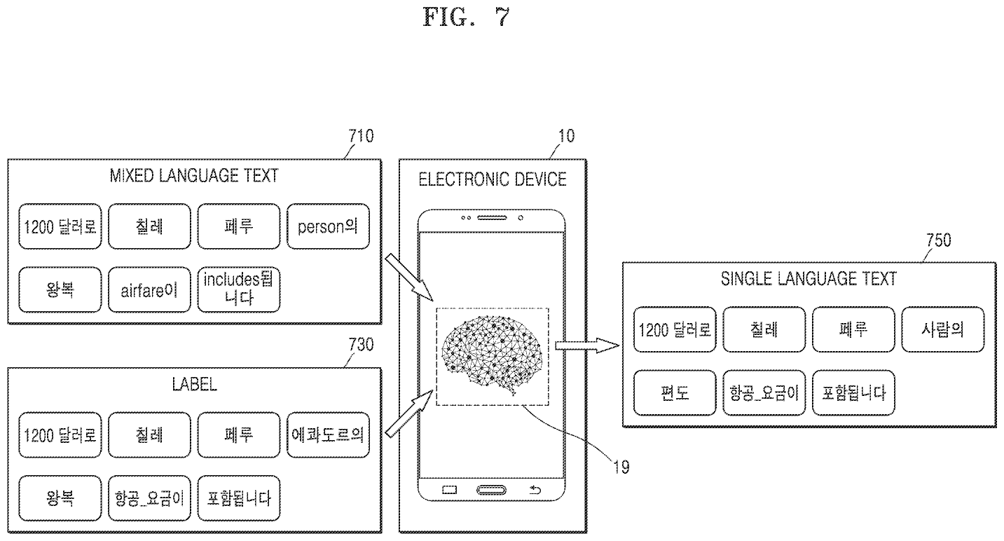

FIG. 7 is a diagram for describing a method of training an AI model by using a mixed language text, according to an embodiment of the disclosure. One or more embodiments regarding the AI model 19 built in the electronic device 10 may be applied by analogy to the AI model 29 built in the server 20.

Referring to FIG. 7, the electronic device 10 may train the AI model 19 to output a single language text 750 corresponding to a mixed language text 710 by using the mixed language text 710 including a plurality of languages and a label 730 including a single language.

The label 730 may be the training text 510 (see FIG. 5) in which a word is not replaced as described with reference to FIG. 5. For example, the label 730 may include a sentence ‘1200 [symbol] [symbol] [symbol] [symbol] The mixed language text 710 may be a text having a meaning different from that of the label 730. The mixed language text 710 may be an arbitrarily generated sentence.

According to an embodiment of the disclosure, the mixed language text 710 may be generated by replacing at least one word from among words included in the label 730 with a word of another language having a non-similar meaning For example, the mixed language text 710 may include a sentence ‘1200 [symbol] ecuador [symbol] [symbol] airfare [symbol] includes

[symbol]

According to an embodiment of the disclosure, the AI model 19 may be trained with the mixed language text 710 so that a loss between the label 730 and the single language text 750 that is output in response to the application of the mixed language text 710 increases. For example, the AI model 19 may be trained with the label 730 and the mixed language text 710 to output a sentence ‘1200 [symbol] [symbol] [symbol] which is different from the label 730, as the single language text 750. The AI model 19 may learn a change in a meaning of a text which occurs when a word included in the text applied to the AI model 19 is changed.

Because the AI model 19 is trained with the mixed language text 710 by using the label 730, the AI model 19 may output a result of accurately translating a mixed language text including a plurality of languages into a single language text including a single language without omission of key words.

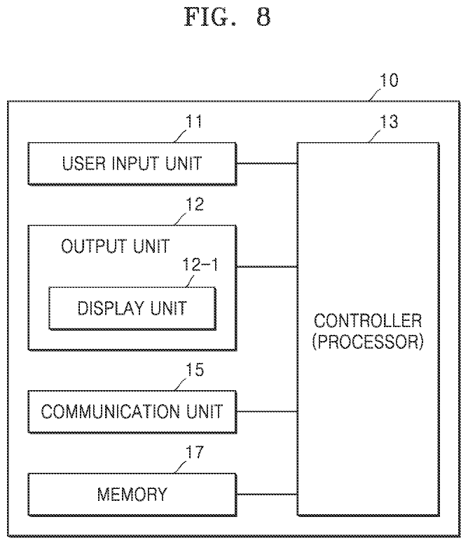

FIG. 8 is a block diagram illustrating the electronic device 10, according to an embodiment of the disclosure.

Referring to FIG. 8, the electronic device 10 may include a user input unit 11, an output unit 12, a processor 13, a communication unit 15, and a memory 17. However, not all of elements illustrated in FIG. 8 are essential elements of the electronic device 10. The electronic device 10 may include more or fewer elements than those illustrated in FIG. 8.

The user input unit 11 refers to a mechanism by which a user inputs data for controlling the electronic device 10. Examples of the user input unit 11 may include, but are not limited to, a touchscreen, a key pad, a dome switch, a touchpad (e.g., a contact-type capacitance method, a pressure-type resistance film method, an infrared sensing method, a surface ultrasound transmission method, an integral tension measuring method, or a piezoelectric effect method), a touchscreen, a jog wheel, and a jog switch. The user input unit 11 may receive a user input required for the electronic device 10 to perform the embodiments described with reference to FIGS. 1 through 7.

The output unit 12 outputs information processed by the electronic device 10. The output unit 12 may output information related to the embodiments described with reference to FIGS. 1 through 7. Also, the output unit 12 may include a display unit 12-1 that displays a result of performing an operation corresponding to an input of a user, a user interface, or an object.

The processor 13 typically controls an overall operation of the electronic device 10. For example, the processor 13 may generally control the user input unit 11, the output unit 12, the communication unit 15, and the memory 17 to provide embodiments of personalizing the AI model 19 described with reference to FIGS. 1 through 7, by executing at least one instruction stored in the memory 17.

For example, the processor 13 may control the electronic device 10 to train the AI model 19, by executing instructions stored in an AI model training module 17a. The same description as that made for the embodiments with reference to FIGS. 1 through 7 will not be given.

For example, the processor 13 may control the electronic device 10 to identify characters constituting a mixed language text applied to the AI model 19, by executing instructions stored in a mixed language text identification module 17b. The same description as that made for the embodiments described with reference to FIGS. 1 through 7 will not be given.

For example, the processor 13 may control the electronic device 10 to apply an identified mixed language text to the AI model, by executing instructions stored in a module 17c for text application to the AI model 19. The same description as that made for the embodiments described with reference to FIGS. 1 through 7 will not be given.

For example, the processor 13 may control the electronic device 10 to identify a single language text output from the AI model 19, by executing instructions stored in a single language text identification module 17d. The same description as that made for the embodiments described with reference to FIGS. 1 through 7 will not be given.

The processor 13 may be at least one general-purpose processor. Also, the processor 13 may include at least one processor manufactured to perform a function of the AI model 19. The processor 13 may perform a function of the AI model 19 described with reference to FIGS. 1 through 7, by executing a software module stored in the memory 17.

The communication unit 15 may include at least one element through which the electronic device 10 communicates with another device (not shown) and the server 20. The other device (not shown) may be a computing device such as, but not limited to, the electronic device 10.

The memory 17 may store at least one instruction and at least one program for processing and controlling of the processor 13, and may store data input to the electronic device 10 or data output from the electronic device 10.

The memory 17 may include at least one type of storage medium from among a volatile memory including random-access memory (RAM) or static random-access memory (SRAM), or a non-volatile memory including a flash memory type, a hard disk type, a multimedia card micro type, a card type memory (e.g., secure digital (SD) or extreme digital (XD) memory), read-only memory (ROM), electrically erasable programmable read-only memory (EPPROM), programmable read-only memory (PROM), a magnetic memory, a magnetic disk, and an optical disk.

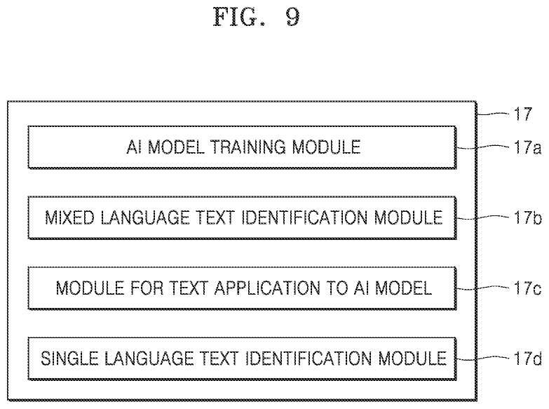

FIG. 9 is a block diagram illustrating a software module of the memory 17 included in the electronic device 10, according to an embodiment of the disclosure.

Referring to FIG. 9, the memory 17 may include the AI model training module 17a, the mixed language text identification module 17b, the module 17c for text application to the AI model, and the single language text identification module 17d, as software modules including instructions used by the electronic device 10 to implement the embodiments described with reference to FIGS. 1 through 7.

However, the electronic device 10 may perform an operation corresponding to an input of a user by using more or fewer software modules than those illustrated in FIG. 9.

For example, the electronic device 10 may train the AI model 19, when the processor 13 executes instructions stored in the AI model training module 17a. The same description as that made for the embodiments described with reference to FIGS. 1 through 7 will not be given.

For example, the electronic device 10 may identify characters constituting a mixed language text applied to the AI model 19, when the processor 13 executes instructions stored in the mixed language text identification module 17b. The same description as that made for the embodiments described with reference to FIGS. 1 through 7 will not be given.

For example, the electronic device 10 may apply the mixed language text to the AI model 19, when the processor 13 executes instructions stored in the module 17c for text application to the AI model 19. The same description as that made for the embodiments described with reference to FIGS. 1 through 7 will not be given.

For example, the electronic device 10 may identify a single language text output from the AI model 19, when the processor 13 executes instructions stored in the single language text identification module 17d. The same description as that made for the embodiments described with reference to FIGS. 1 through 7 will not be given.

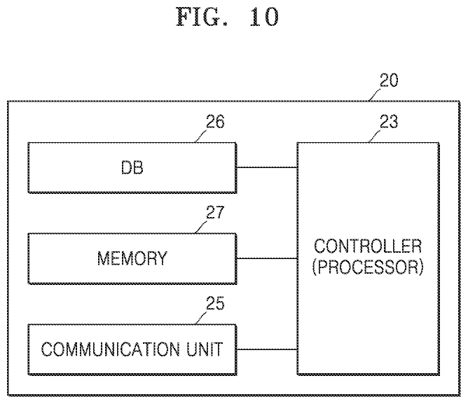

FIG. 10 is a block diagram illustrating the server 20, according to an embodiment of the disclosure.

Referring to FIG. 10, the server 20 according to an embodiment of the disclosure may include a communication unit 25, a memory 27, a database (DB) 26, and a processor 23.

The communication unit 25 may include one or more elements through which the server 20 communicates with the electronic device 10.

The memory 27 may store at least one instruction and at least one program for processing and controlling of the processor 23, and may store data input to the server 20 or data output from the server 20.

The DB 26 may store data received from the electronic device 10. The DB 26 may encrypt and store data received from a plurality of electronic devices.

The processor 23 controls an overall operation of the server 20. For example, the processor 23 may control the DB 26 and the communication unit 25, by executing programs stored in the memory 27 of the server 20. The processor 23 may perform an operation of the server 20 described with reference to FIGS. 1 through 7, by executing the programs.

For example, the processor 23 may control the server 20 to train the AI model 29, by executing instructions stored in an AI model training module 27a. The same description as that made for the embodiments described with reference to FIGS. 1 through 7 will not be given.

For example, the processor 23 may control the server 20 to identify characters constituting a mixed language text applied to the AI model 29, by executing instructions stored in a mixed language text identification module 27b. The same description as that made for the embodiments described with reference to FIGS. 1 through 7 will not be given.

For example, the processor 23 may control the server 20 to apply the identified mixed language text to the AI model 29, by executing instructions stored in a module 27c for text application to the AI model 29. The same description as that made for the embodiments described with reference to FIGS. 1 through 7 will not be given.

For example, the processor 23 may control the server 20 to identify a single language text output from the AI model 29, by executing instructions stored in a single language text identification module 27d. The same description as that made for the embodiments described with reference to FIGS. 1 through 7 will not be given.

The processor 23 may be at least one general-purpose processor. Also, the processor 23 may include at least one processor manufactured to perform a function of the AI model 29. The processor 23 may perform a function of the AI model described with reference to FIGS. 1 through 7, by executing a software module stored in the memory 27.

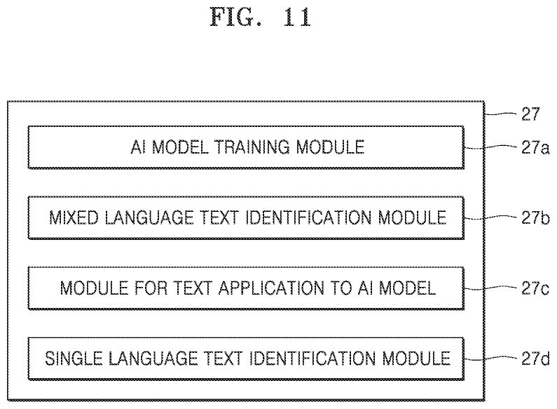

FIG. 11 is a block diagram illustrating a software module of the memory 27 included in the server 20, according to an embodiment of the disclosure.

Referring to FIG. 11, the memory 27 may include the AI model training module 27a, the mixed language text identification module 27b, the module 27c for text application to the AI model, and the single language text identification module 27d, as software modules using which the server 20 performs the embodiments described with reference to FIGS. 1 through 7,.

However, the server 20 may perform an operation by using more or fewer software modules than those illustrated in FIG. 11.

For example, the server 20 may train the AI model 29, when the processor 23 executes instructions stored in the AI model training module 27a. The same description as that made for the embodiments described with reference to FIGS. 1 through 7 will not be given.

For example, the server 20 may identify characters constituting a mixed language text applied to the AI model 29, when the processor 23 executes instructions stored in the mixed language text identification module 27b. The same description as that made for the embodiments described with reference to FIGS. 1 through 7 will not be given.

For example, the server 20 may apply the mixed language text to the AI model 29, when the processor 23 executes instructions stored in the module 27c for text application to the AI model 29. The same description as that made for the embodiments described with reference to FIGS. 1 through 7 will not be given.

For example, the server 20 may identify a single language text output from the AI model 29, when the processor 23 executes instructions stored in the single language text identification module 27d. The same description as that made for the embodiments described with reference to FIGS. 1 through 7 will not be given.

A machine-readable storage medium may be provided in a form of a non-transitory storage medium. Here, ‘non-transitory’ denotes that the storage medium does not include a signal and is tangible, but does not distinguish whether data is stored semi-permanently or temporarily in the storage medium. For example, the ‘non-transitory storage medium’ may include a buffer in which data is temporarily stored.

According to an embodiment of the disclosure, methods according to various embodiments of the disclosure may be provided in a computer program product. The computer program product is a product purchasable between a seller and a purchaser. The computer program product may be distributed in a form of machine-readable storage medium (e.g., a compact disc read-only memory (CD-ROM)), or distributed (e.g., downloaded or uploaded) through an application store or directly or online between two user devices (e.g., smart phones). When distributed online, at least part of the computer program product (e.g., a downloadable application) may be temporarily generated or at least temporarily stored in a machine-readable storage medium, such as a memory of a manufacturer's server, a server of an application store, or a relay server.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of controlling an electronic device, the method comprising:
receiving, by the electronic device, an input of a user regarding first text including a plurality of languages;
identifying, by the electronic device, the first text;
applying, by the electronic device, the first text to an artificial intelligence (AI) model trained based on a corpus in which words of the plurality of languages are mapped to each other;
identifying, by the electronic device, second text corresponding to the first text from the AI model, the second text including a single language from among the plurality of languages; and
displaying, by the electronic device, the second text.

2. The method of claim 1, wherein the AI model is trained by using the corpus generated based on the words of the plurality of languages which co-occur from training texts comprising the plurality of languages.

3. The method of claim 2, wherein the AI model is trained by using the corpus generated by mapping words included in the training texts in an order of frequency of co-occurrence.

4. The method of claim 1, wherein the AI model is trained by using the corpus generated based on training text in which collocations are merged.

5. The method of claim 4, wherein the AI model is trained by using the corpus generated by merging collocations based on a number of co-occurrences of words included in the training text.

6. The method of claim 1, wherein the AI model is trained with second training text generated by replacing a first word of a first language included in first training text with a second word of a second language, based on the corpus.

7. The method of claim 6,
wherein the second training text is generated by replacing the first word with the second word mapped to have a meaning similar to a meaning of the first word, based on the corpus, and
wherein the AI model is trained with the second training text so that a loss between the first training text and third training text output from the AI model in response to application of the second training text to the AI model decreases.

8. The method of claim 6,
wherein the second training text is generated by replacing the first word with the second word not mapped to have a meaning similar to a meaning of the first word, based on the corpus, and
wherein the AI model is trained with the second training text so that a loss between the first training text and third training text output from the AI model in response to application of the second training text to the AI model increases.

9. The method of claim 6, wherein the AI model is trained with the first training text comprising the single language and the second training text comprising the plurality of languages.

10. A non-transitory computer-readable recording medium having recorded thereon a computer program including instructions which, when executed, cause an electronic device to perform the method of claim 1.

11. An electronic device, the electronic device comprising:
a user interface device configured to receive an input of a user regarding first text including a plurality of languages and output second text including a single language from among the plurality of languages;
a processor; and
a memory storing instructions which, when executed by the processor, cause the electronic device to:
identify the first text,
apply the first text to an artificial intelligence (AI) model trained based on a corpus in which words of the plurality of languages are mapped to each other,
identify the second text corresponding to the first text from the AI model, and
display the second text.

12. The electronic device of claim 11, wherein the AI model is trained by using the corpus generated based on words of the plurality of languages which co-occur from training texts comprising the plurality of languages.

13. The electronic device of claim 12, wherein the AI model is trained by using the corpus generated by mapping words included in the training texts in an order of frequency of co-occurrence.

14. The electronic device of claim 11, wherein the AI model is trained by using the corpus generated based on a training text in which collocations are merged.

15. The electronic device of claim 14, wherein the AI model is trained by using the corpus generated by merging collocations based on a number of co-occurrences of words included in the training text.

16. The electronic device of claim 11, wherein the AI model is trained with second training text generated by replacing a first word of a first language included in first training text with a second word of a second language, based on the corpus.

17. The electronic device of claim 16,
wherein the second training text is generated by replacing the first word with the second word mapped to have a meaning similar to a meaning of the first word, based on the corpus, and
wherein the AI model is trained with the second training text so that a loss between the first training text and a third training text output from the AI model in response to application of the second training text to the AI model decreases.

18. The electronic device of claim 16,
wherein the second training text is generated by replacing the first word with the second word not mapped to the first word, based on the corpus, and
wherein the AI model is trained with the second training text so that a loss between the first training text and a third training text output from the AI model in response to application of the second training text to the AI model increases.

19. The electronic device of claim 16, wherein the AI model is trained with the first training text comprising the single language and the second training text comprising the plurality of languages.
